(19) United States
(12) Patent Application Publication
(10) Pub. No.: US 2022/0316874 A1
(43) Pub. Date: Oct. 6, 2022

(54) Laser Level System

(71) Applicant: Milwaukee Electric Tool Corporation, Brookfield, WI (US)

(72) Inventors: Steven K. Hansen, Port Washington, WI (US); Max D. Mutza, Waukesha, WI (US); John Norbert Winkler, New Berlin, WI (US); Gregory R. Strommen, Greendale, WI (US); Jacob D. Hadfield, Brookfield, WI (US)

(21) Appl. No.: 17/716,615

(22) Filed: Apr. 8, 2022

Related U.S. Application Data
(63) Continuation of application No. PCT/US2022/023284, filed on Apr. 4, 2022.
(60) Provisional application No. 63/194,480, filed on May 28, 2021.
(60) Provisional application No. 63/175,878, filed on Apr. 16, 2021.
(60) Provisional application No. 63/170,803, filed on Apr. 5, 2021.

(51) Int. Cl. G01C 9/02

(52) U.S. Cl. CPC G01C 9/02

(57) ABSTRACT

A laser level assembly is provided. Various methods of managing communications between laser levels and detectors are provided. In one or more methods, upon receiving a selection of a communication channel the laser level emits a laser with certain characteristics, such as by adjusting the rotation speed, rotational direction, and/or emitting the laser in a repeating on/off pattern.

### CROSS-REFERENCE TO RELATED PATENT APPLICATIONS

The present application is a continuation of International Application No. PCT/US2022/023284, filed Apr. 4, 2022, which claims the benefit of and priority to U.S. Provisional Application No. 63/170,803, filed on Apr. 5, 2021, U.S. Provisional Application No. 63/175,878, filed on Apr. 16, 2021, and U.S. Provisional Application No. 63/194,480, filed on May 28, 2021, each of which is incorporated herein by reference in its entirety.

### BACKGROUND OF THE INVENTION

The present invention relates generally to the field of tools. The present invention relates specifically to a laser level assembly including a detector and a laser level, such as a rotary laser level.

### SUMMARY OF THE INVENTION

One embodiment of the invention relates to a method of using a rotary laser level and a detector. The method includes receiving a first signal at the rotary laser level, the first signal indicating a first selection of a first communication channel from among a plurality of communication channels. The method further includes emitting a first laser beam from the rotary laser level, the first laser beam rotating with respect to the rotary laser level at a first rotation speed that corresponds to the first communication channel. The method further includes receiving a second signal at the detector, the second signal indicating a second selection of the first communication channel from among the plurality of communication channels. The method further includes detecting a second laser beam at the detector, determining, at the detector, a detected rotation speed of the second laser beam, and analyzing the detected rotation speed to determine whether the second laser beam is the first laser beam emitted by the rotary laser level.

Another embodiment of the invention relates to a laser level including a laser emitter and a receiver. The a laser emitter is configured to emit a rotating laser beam from the rotary laser level. The receiver is configured to receive a signal that indicates a selection of a first communication channel from among a plurality of communication channels. The laser emitter is further configured to actuate the rotating laser beam between being on and off in a repeating pattern that corresponds to the first communication channel.

Another embodiment of the invention relates to a laser level detector including a detector panel and a processing unit. The detector panel is configured to receive a first laser beam, where the first laser beam was emitted by a first emitter and is received at a first portion of the detector panel. The detector panel is further configured to receive a second laser beam at the detector panel. The processing unit is configured to analyze whether the second laser beam was received at the first portion of the detector panel, and determine whether the second laser beam was emitted by the first emitter based on the analyzing whether the second laser beam was received at the first portion of the detector panel.

Another embodiment of the invention relates to a method of using a rotary laser level and a detector. The method includes emitting a rotating laser from a rotary laser level and receiving a first signal at the rotary laser level. The first signal indicates a first selection of a first communication channel from among a plurality of communication channels. As a result of receiving the first signal, a rotation speed of the rotating laser is adjusted to a first rotation speed that corresponds to the first communication channel. A second signal is received at a detector. The second signal indicates a second selection of the first communication channel from among the plurality of communication channels. Upon detecting a received laser, the detector determines a detected rotation speed of the received laser. The detector analyzes the detected rotation speed to determine whether the received laser is the rotating laser emitted by the rotary laser level.

Another embodiment of the invention relates to a method of using a rotary laser level and a detector that includes emitting a rotating laser from a rotary laser level. A signal is received at the rotary laser level that indicates a selection of a first communication channel from among a plurality of communication channels. As a result of the selection of the first communication channel, the laser level turns the emitted laser on and off in a pattern, such as a repeating pattern.

Another embodiment of the invention relates to a method that includes receiving a first laser at a first portion of a detector panel of a detector. Then, a second laser is received at the detector panel. The detector analyzes the location where the second laser was received to determine whether the second laser was received in the same portion as the first laser. If not, the second laser is discarded by the detector without further processing, otherwise the second laser is processed further by the detector.

Another embodiment of the invention relates to a method including emitting a laser from a rotary laser. A first laser is detected at a first location of a detector panel. Subsequently a second laser is detected at a second location of the detector panel. The detector compares the first location to the second location and based on that comparison determines whether to pair the detector with the rotary laser level.

Another embodiment of the invention relates to a method including emitting a rotating laser from a rotary laser level. A detector detects a received laser and determines an intensity of the received laser. The intensity is analyzed to determine whether the received laser is the rotating laser emitted by the rotary laser level, e.g., whether the determined intensity corresponds with an expected intensity.

Another embodiment of the invention relates to a method of using a rotary laser level and a detector. The method includes emitting a rotating laser from a rotary laser level and receiving a first signal at the rotary laser level. The first signal indicates a first selection of a first communication channel from among a plurality of communication channels. As a result of receiving the first signal, a rotation speed of the rotating laser is adjusted to a first rotation speed that corresponds to the first communication channel, and the rotational direction is modified and/or confirmed to correspond to the first communication channel. A second signal is received at a detector. The second signal indicates a second selection of the first communication channel from among the plurality of communication channels. Upon detecting a received laser, the detector determines a detected rotation speed and a detected rotational direction of the received laser. The detector analyzes the detected rotation speed and the detected rotational direction to determine whether the received laser is the rotating laser emitted by the rotary laser level.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser measuring system, according to an exemplary embodiment.

FIG. 2 is a schematic view of emission patterns from a laser level of FIG. 1, according to an exemplary embodiment.

FIG. 3 is a front view of the detector of FIG. 1, according to an exemplary embodiment.

FIG. 4 is a method of using the laser measuring system of FIG. 1, according to an exemplary embodiment.

FIG. 5 is a block diagram of one of the laser levels of FIG. 1, according to an exemplary embodiment.

FIG. 6 is a block diagram of the detector of FIG. 1, according to an exemplary embodiment.

FIG. 7 is a perspective view of a laser measuring system, according to an exemplary embodiment.

### DETAILED DESCRIPTION

Referring generally to the figures, various embodiments of a laser system, such as a rotary laser level and a laser level detector, are shown. As discussed herein, Applicant has developed a number of improvements to the functionality and/or control of laser levels, and specifically to rotary laser levels. Occasionally a worksite will include multiple laser levels. To avoid a laser light detector analyzing signals from a laser level other than the intended laser level, Applicant has developed several methods of pairing laser levels and detectors via managing their communications.

In one embodiment, a rotary laser level and a detector are paired by adjusting the laser emitted by the rotary laser level based on a selection of a communication channel. In another embodiment, a detector is configured to only process laser light received within a certain expected portion of the detector panel, thereby enabling the detector to only process lasers received from the paired rotary laser level. In another embodiment, the detector compares an intensity of a received laser signal to an expected intensity to determine whether the light received is from a certain rotary laser level.

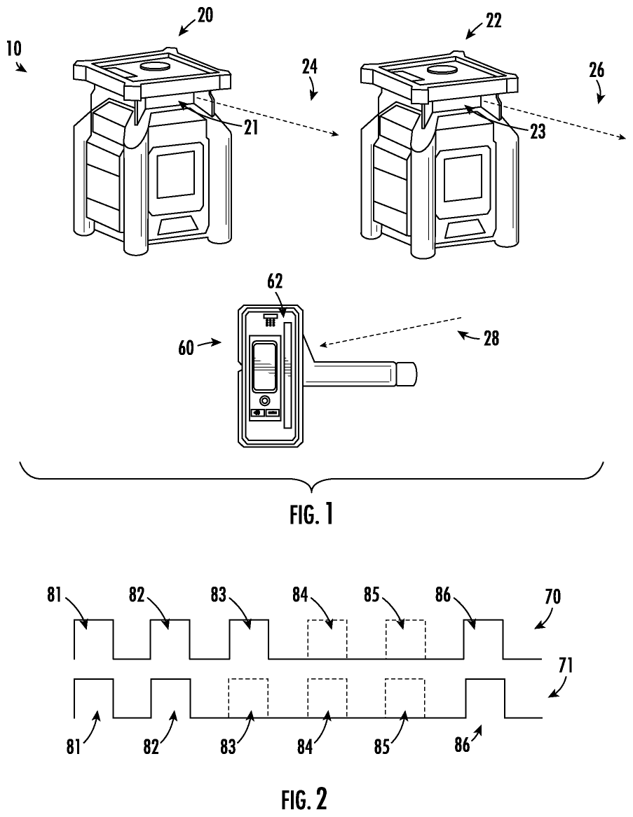

Referring to FIG. 1, an orientation and/or position-measuring system, shown as laser measuring system 10, is shown according to an exemplary embodiment. Laser level 20 emits a signal, such as a light signal from laser emitter 21, shown as rotating laser beam 24. Laser level 22 emits a signal, such as a light signal from laser emitter 23, shown as rotating laser beam 26. In various embodiments, rotating laser beam 24 and rotating laser beam 26 are emitted by a laser emitting assembly in a rotating fashion from the housing of the respective laser level.

Detector 60 includes a panel, shown as detector panel 62, to detect signals, shown as laser 28. In a specific embodiment, detector panel 62 is a light-responsive electronic sensor, such as an array of photodiodes. As will be explained in more detail below, Applicant has developed several methods for managing communications between detector 60 and laser levels 20, 22.

According to a first exemplary method of managing communications, laser level 20 emits rotating laser beam 24. Laser level 20 receives a signal that indicates a selection of a first communication channel from among a plurality of communication channels. For example, the signal is received as a result of a user actuating one or more user-interface elements 61 (e.g., a button) on laser level 20 to generate an electronic signal that indicates the selection.

In various embodiments, the selection is of a first communication channel from among a plurality of communication channels. For example, the laser level 20 is configured with, such as via being stored in memory, a plurality of communication channels (e.g., channel 1, channel 2, etc.). The user may actuate one or more user-interface elements (e.g., buttons) on laser level 20 to select a communication channel.

In a specific embodiment, each channel corresponds to one or more rotation speeds. For example, in a specific embodiment channel 1 includes 280 rpm, 580 rpm, and 780 rpm, and channel 2 includes 320 rpm, 620 rpm, and 820 rpm, and channel 3 includes 340 rpm, 640 rpm, and 840 rpm. In various embodiments, each communication channel of the plurality of communications channels corresponds to a rotation speed that does not correspond to any of the other communications channels (e.g., any given rotation speed corresponds to at most one communication channel).

In various embodiments, a first communication channel corresponds to the first rotation speed and a second rotation speed, and a second communication channel corresponds to a third rotation speed between the first rotation speed and the second rotation speed. In one example, the first communication channel corresponds to a first rotation speed of 280 rpm and a second rotation speed of 580 rpm, and the second communication channel corresponds to a third rotation speed of 320 rpm.

When laser level 20 receives the signal indicating the selection of a channel, for example channel 1, laser level 20 adjusts a rotation speed of laser beam 24 to correspond to the selected channel. For example, if laser level 20 receives the selection of channel 1, laser level 20 adjusts the speed that the emission of laser beam 24 rotates around laser level 20 to one of 280 rpm, 580 rpm, or 780 rpm. Stated another way, subsequent to receiving the signal indicating a selection, laser level 20 emits a laser that rotates with respect to the laser level 20 at a first rotation speed that corresponds to the first communication channel indicated by the selection.

To s detector 60 with laser level 20, detector 60 receives a signal that indicates a selection. For example, the signal could be received by a user actuating one or more user-interface elements (e.g., a button) on detector 60 to generate an electronic signal that indicates the selection. In a specific embodiment, the selection is of a first communication channel from among the plurality of communication channels described above.

Subsequently, detector 60 receives laser 28. Detector 60 initially determines a rotation speed of laser 28. Detector 60 then analyzes the determined rotation speed to determine whether the received laser 28 is the laser beam 24 from laser level 20, or whether the received laser 28 is from another laser level (e.g., laser beam 26 from laser level 22). For example, if detector 60 receives a selection of channel 1, detector 60 is configured to look for lasers rotating at one of the following rotation speeds: 280 rpm, 580 rpm, or 780 rpm. Detector 60 is also configured to discard lasers that are rotating at other rotational speeds without further processing. In various embodiments, the detector 60 then determines to pair the detector 60 to the laser level 20 as a result of determining the second laser 28 is the first laser beam 24 emitted by the rotary laser 20.

Once paired, the detector 60 analyzes laser beams that are received in the future to determine if the laser beam was emitted from the laser level that the detector 60 is paired with (e.g., by analyzing laser beam characteristics, such as rotation speed, direction, etc.). Once the detector 60 confirms the laser beam was emitted by the laser level the detector 60 is paired with, the detector 60 further analyzes features of the laser beam, such as by analyzing a position of the laser beam on the detector panel as a result of determining whether the received laser beam was emitted by laser level the detector is paired with. The analysis of the position may be used to determine a relative orientation of the detector and/or the corresponding laser level.

Referring to FIG. 2, according to a second exemplary method of managing communications, laser level 20 receives a signal indicating the selection of a communication channel from among a plurality of communication channels. In this exemplary method, each communication channel corresponds to a pattern, such as a repeating pattern, of the laser being turned off and on.

Referring to FIG. 2, exemplary emission patterns of a laser being turned on and off are depicted. For example, the laser level 20 actuates the laser between being on and off in a first repeating pattern that corresponds to the selected first communication channel. Emission pattern 70 and emission pattern 71 each include a series of communication elements, shown as bits 81, 82, 83, 84, 85, and 86. In this example, emission pattern 70 communicates the pattern 111001 and emission pattern 71 communicates the pattern 110001. In particular, for emission pattern 70 the laser was turned on (1) for the first rotation of the laser level, remained on (1) for the second rotation, remained on (1) for the third rotation, turned off (0) for the fourth rotation, turned off (0) for the fifth rotation, and turned on (1) for the sixth rotation.

In various embodiments, the laser is actuated on and off in repeating pattern that corresponds to the first communication channel. In various embodiments, there are a plurality of communication channels, and each of the plurality of communication channels corresponds to at least one repeating pattern that is unique to that respective communication channel (e.g., the repeating pattern does not correspond to any of the other communication channels).

In one exemplary method of implementing communication channels based on emission patterns similar to emission patterns 70, 71, a user selects a communication channel from among a plurality of communication channels. For example, communication channel 1 corresponds to the repeating pattern 10110, communication channel 2 corresponds to the repeating pattern 0111, and communication channel 3 corresponds to the repeating pattern 0110. When one of the respective communication channels is selected on laser level 20, laser level 20 modulates laser beam 24 such that laser beam 24 is turned off for the 0s (zeroes) and turned on for the 1s (ones).

In use, detector 60 also receives a signal indicating the selection of a communication channel. Based on that selection, detector 60 analyzes received laser 28 to determine if the laser 28 is turning off and on in a pattern that corresponds to the selected communication channel. For example, if detector 60 determines that laser 28 is turning off and on in the following pattern . . . 101101011010110 . . . , then detector 60 will determine that received laser 28 is communicating on channel 1. In this situation, if detector 60 has been instructed to also operate on channel 1, then detector 60 will further process the received laser 28. On the other hand, if detector 60 has been instructed to operate on a channel other than channel 1, then detector 60 will discard laser 28 without further processing.

Stated another way, the method includes determining, at the detector 60, a repeating pattern of the received laser 28, and analyzing, at the detector 60, whether the received laser 28 is the first laser beam 24 emitted by the laser level 20 based on whether the second repeating pattern (detected by the detector 60) matches the first repeating pattern (emitted by the laser level 20).

In a specific embodiment, detector 60 can be configured to operate on channel 0, which includes detector 60 listening for each of the available channels. This may be appropriate where the user believes there is a low chance of a miscommunication (e.g., there is only a single laser level onsite) and the user does not want to risk the detector 60 ignoring a valid laser signal.

According to a third exemplary method of managing communications, the plurality of communication channels of each of first and second exemplary methods are combined. For example, channel 1 includes a repeating signal of 0101 emitted at either 280 rpm, 580 rpm, or 780 rpm, and channel 2 includes a repeating signal of 0111 emitted at either 320 rpm, 620 rpm, or 820 rpm, and channel 3 includes a repeating signal of 0110 emitted at either 340 rpm, 640 rpm, or 840 rpm.

According to a fourth exemplary method of managing communications, detector 60 determines whether to analyze laser 28 based on the location where laser 28 is received. Referring to FIG. 3, in a specific embodiment, detector 60 includes detector panel 62. Initially, laser 28 is received at a first portion 64 of detector panel 62. Subsequently, detector 62 processes light received in first portion 64 and discards light received elsewhere.

As an example, when detector 60 receives a laser at second portion 66 or third portion 68, detector 60, such as processing unit 69 of detector 60, determines the light was received somewhere other than first portion 64 and therefore discards the laser signal (e.g., that laser does not receive further substantive processing). When detector 60 receives a laser at first portion 64, detector 60, such as processing unit 69 of detector 60, determines the light was received at first portion 64 and therefore performs further substantive processing of the received light (e.g., communicating the location of the received light to a user). Stated another way, detector 60 receives a second received laser at the detector panel 62, analyzes whether the second received laser was received at the first portion 64 of the detector panel 60, and determines whether the second received laser came from the original laser emitter based on analyzing whether the second laser was received at the first portion 64 of the detector panel 62. The determination is at least in part based on the analyzing whether the second received laser was received at the first portion of the detector panel. In various embodiments the analysis on detector 60 is performed at processing unit 69.

In a specific embodiment, detector 60 averages the light received at detector panel 62 (e.g., by averaging the signals generated by multiple instances of the rotating laser intersecting the detector panel 62 to generate an average location of those intersections). This approach enables a user to make slight movement and adjustments to the laser level and/or the detector without triggering the detector 60 to improperly ignore the adjusted laser.

According to a fifth exemplary method of managing communications, a detector 60 is moved into a laser in a specifically selected manner. For example, detector 60 receives a signal (e.g., via user input) that light will be received from the top of detector panel 62 then progress towards the center of detector panel 62. Therefore, to pair detector 60 with a specific laser level 20, a user raises the detector 60 (and therefore also detector panel 62) from below the path and into the path of laser beam 24 emitted by laser level 20. In this example, laser 28 (which was laser beam 24 when emitted by laser level 20) is first received at a top of detector panel 62, and subsequently laser 28 slowly moves down towards the bottom of detector panel 62 as the user continues to raise detector 60.

Detector 60 analyzes the series of locations of received laser 28 and determines that the pairing process (e.g., high to low movement on detector panel 62) has been satisfied. At that point detector 60 is paired with the respective laser level and continues to process signals received from the selected laser level (e.g., by looking for the detected rotation speed, the detected rotational direction, and/or the detected on/off pattern).

According to a sixth exemplary method of managing communications, detector 60 measures (e.g., analyzes) an intensity of received laser 28 to determine whether the received laser 28 was emitted by the targeted laser level. Initially, detector 60 receives a signal (e.g., laser detector determining intensity of a laser based on peak intensity for a laser received after the detector and the laser pair; user input) indicating an intensity for a laser received from the target laser level. As an example, the detector 60 detects a laser having a measured intensity of 0.8 mW.

Subsequently, detector 60 detects one or more laser 28 signals at detector panel 62. Each of the laser 28 signals are analyzed to determine an intensity. For example, a first laser 28 is measured at 0.8 mW, a second laser 28 is measured at 1.1 mW, and a third laser 28 is measured at 0.4 mW. In this example, detector 60 was looking for light at a similar intensity that was previously identified, which is expected to have a measured intensity of at or near 0.8 mW. Therefore, detector 60 continues processing the laser received at the expected targeted intensity and discards the remaining lasers. In a specific embodiment, the detector 60 continues processing the laser received within a range of intensities with respect to the initially measured intensity (e.g., plus or minus 10% of the initially measured intensity, which in the example above was 0.8 mW).

According to a seventh exemplary method of managing communications, aspects of two or more of the exemplary methods described above are combined into a single method.

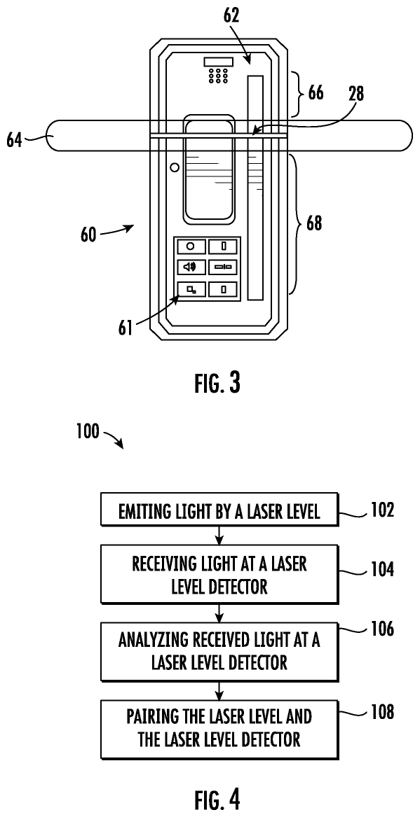

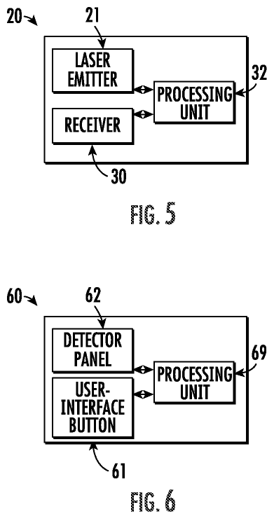

Referring to FIG. 4, are various aspects of one or more of the exemplary communication methods are described herein. In this exemplary process 100, light is emitted by a laser level, such as a rotary laser level (step 102). In various situations, the light is emitted at a specified rotation speed, rotational direction, at a repeating on/off pattern, etc. Light is received at a detector (step 104). Subsequently, detector 60 analyzes the received light (step 106), such as to determine whether the received light corresponds to the light emitted from the laser level. In this way, miscommunication between laser levels and/or detectors can be reduced. Optionally, based on the analysis the detector is paired with the laser level for further work (step 108).

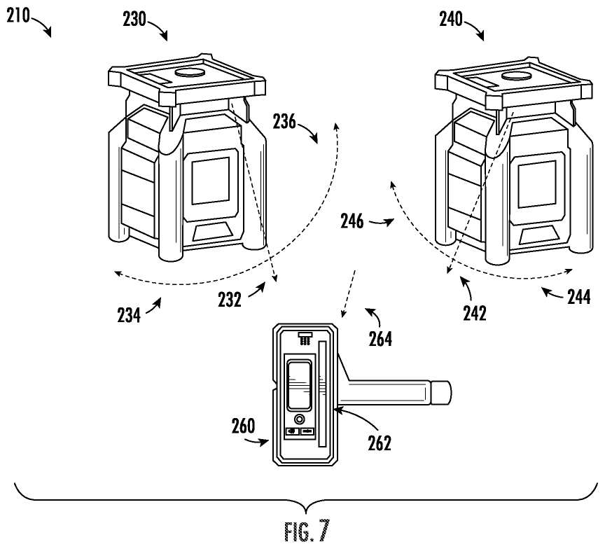

Referring to FIGS. 5-6, provided are block diagrams of laser level 20 and detector 60. In various embodiments laser level 20 includes laser emitter 21, receiver 30, and processing unit 32. Laser emitter 21 is configured to emit a laser beam, such as a rotating laser beam, that has certain selected characteristics, such as a selected rotation speed and/or direction. Receiver 30 is configured to receive an electronic signal, such as a radio signal and/or a signal generated by a button on laser level 20, with the signal indicating a communication and/or user selection. Processing unit 32 is configure to receive and send communications with laser emitter 21 and receiver 30, such as by analyzing signals from receiver 30 and sending instructions to laser emitter 21.

In various embodiments, detector 60 includes a detector panel 62, a processing unit 69, and a user-interface element 61. Detector panel 62 is configured to detect received light, such as a received laser beam from a laser level. Processing unit 69 is configured to receive signals from detector panel 62 and/or a user-interface element 61 indicating light that was detected, analyze the signals that indicate characteristics of the light, and generate signals indicating results of the analysis (e.g., indicating a location of where the light was received, whether an adjustment needs to be made to the detector 60 and/or the corresponding laser level).

Referring to FIG. 7, an orientation and/or position-measuring system, shown as laser measuring system 210, is shown according to an exemplary embodiment. Laser measuring system 210 is substantially the same as laser measuring system 10 except for the differences discussed herein. Laser level 230 and laser level 240 are each configured to emit a laser in a rotating fashion in either a clockwise or counterclockwise direction. In particular, laser level 230 is configured to emit laser 232 in rotational direction 234 or opposing rotational direction 236, and laser level 240 is configured to emit laser 242 in rotational direction 244 or opposing rotational direction 246.

One method of increasing the number of communication channels is by selectively rotating a laser clockwise (CW) or counterclockwise (CCW), depending on the channel selected. In this way, the number of available channels can be doubled by selecting the rotational direction in combination with selecting different rotation speeds and/or repeating on/off patterns to indicate different channels of communication. Based on these selections, the laser detector 260 can analyze the permutations (e.g., rotation speeds, rotational directions, and/or repeating on/off patterns) of received laser(s) to identify which received lasers should be analyzed and which received lasers should be ignored. It is contemplated herein that adjusting the rotational direction can be combined with one or more of the other methods described herein.

For example, the method of pairing a detector with a laser level may include determining, at the detector, a detected rotational direction of the received laser by the detector, and analyzing the detected rotational direction to determine whether the laser is the same as the laser emitted by the laser level.

In various embodiments, laser level 230 and laser level 240 are configured to emit a laser on one of multiple channels. Each channel corresponds to at least one rotational direction (CW or CCW) and at least one rotational speed.

As an example for illustrative purposes, laser level 230 and laser level 240 are configured to emit a laser on one of four channels: channel 1, channel 2, channel 3, and channel 4. Channel 1 includes CW 280 rpm, CW 580 rpm, and CW 780 rpm. Channel 2 includes CCW 280 rpm, CCW 580 rpm, and CCW 780 rpm. Channel 3 includes CW 320 rpm, CW 620 rpm, and CW 820 rpm. Channel 4 includes CCW 320 rpm, CCW 620 rpm, and CCW 820 rpm.

If laser level 230 has been instructed to communicate on channel 1, laser level 230 initiates clockwise (CW) rotation of laser 232 in rotational direction 234 at one of 280 rpm, 580 rpm or 780 rpm. If laser level 230 has been instructed to communicate on channel 2, the laser level 230 initiates counterclockwise (CCW) rotation of laser 232 in rotational direction 236 at one of 280 rpm, 580 rpm or 780 rpm. If the laser level 230 has been instructed to communicate on channel 3, the laser level 230 initiates clockwise (CW) rotation of laser 232 in rotational direction 234 at one of 320 rpm, 620 rpm or 820 rpm. If the laser level 230 has been instructed to communicate on channel 4, the laser level 230 initiates counterclockwise (CCW) rotation of laser 232 in rotational direction 236 at one of 320 rpm, 620 rpm or 820 rpm.

In a specific embodiment, the laser level 260 detector receives a channel selection by a user. In a specific embodiment, if the user selects a catch-all channel, such as channel 0, then the laser level detector 260 looks for all permutations (e.g., rotation speeds, rotational directions, and/or repeating on/off patterns). On the other hand, if user selects a specific channel for the laser level detector 260 other than channel 0, then the detector 260 only looks for the permutations (e.g., rotation speeds, rotational directions, and/or repeating on/off patterns) associated with that channel, and all lasers detected at other permutations are ignored.

To continue the example above, if the laser level detector 260 is looking for a laser on channel 1, then the laser level detector 260 analyzes laser(s) 264 received at detection panel 262 to determine a rotational direction and speed of the laser(s) 264. Because detector 260 was instructed to look for a laser on channel 1, detector 260 discards any received laser 264 that is not being rotated in a clockwise direction and at 280 rpm, 580 rpm or 780 rpm, and processes the remaining laser as the target laser.

Referring to FIG. 5, if the laser level 230 enters an alarm state, the laser level 230 adjusts the rotation of laser 232. For example, laser level 230 adjusts the rotational direction 234, 236 of laser 232 and/or laser level 230 adjusts the rotation speed of laser 232. The new rotational direction and/or rotational speed indicates that an alarm has been triggered by laser level 230.

The laser detector 260 determines that a new rotational speed and/or rotational direction has been detected, and notifies the user. In a specific embodiment, different rotation speeds (e.g., 150 rpm, 200 rpm) and/or rotational directions (e.g., clockwise, counterclockwise) indicate different alarm states (e.g., the laser level has been bumped, the height of the laser level has changed).

For example, if the laser level 230 is bumped, the laser level 230 starts rotating at 150 rpm. The laser detector 260 detects the new rotation speed and notifies the user the laser level 230 has been bumped.

As another example, if the height of the laser level 230 is changed, the laser level 230 starts rotating at 200 rpm. The laser detector 260 detects the new rotation speed and notifies the user the height of the laser level 230 has changed.

As another example, if the height of the laser level 230 is changed, the laser level 230 starts rotating at 300 rpm and in the opposite rotational direction (e.g., from direction 234 to direction 236). The laser detector 260 detects the new rotation speed and opposite rotation direction, and notifies the user the height of the laser level 230 has changed.

As another example, one or more of the communication channels can include both rotational directions. For example, channel 1 includes clockwise rotation at 280 rpm and counterclockwise rotation at 360 rpm, and channel 2 includes counterclockwise rotation at 280 rpm, and clockwise rotation at 360 rpm.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A method of using a rotary laser level and a detector, the method comprising:
receiving a first signal at the rotary laser level, the first signal indicating a first selection of a first communication channel from among a plurality of communication channels;
emitting a first laser beam from the rotary laser level, the first laser beam rotating with respect to the rotary laser level at a first rotation speed that corresponds to the first communication channel;
receiving a second signal at the detector, the second signal indicating a second selection of the first communication channel from among the plurality of communication channels;
detecting a second laser beam at the detector;
determining, at the detector, a detected rotation speed of the second laser beam; and
analyzing the detected rotation speed to determine whether the second laser beam is the first laser beam emitted by the rotary laser level.

2. The method of claim 1, wherein the first signal received at the rotary laser level is generated as a result of a user-interface element on the rotary laser level being actuated.

3. The method of claim 1, analyzing, at the detector, a position of the second laser beam as a result of determining whether the second laser beam is the first laser beam emitted by the rotary laser level.

4. The method of claim 1, comprising:
determining, at the detector, a detected rotational direction of the second laser beam; and
analyzing the detected rotational direction to determine whether the second laser beam is the first laser beam emitted by the rotary laser level.

5. The method of claim 1, wherein each communication channel of the plurality of communications channels corresponds to a rotation speed that does not correspond to any of the other communications channels.

6. The method of claim 1, wherein the first communication channel corresponds to the first rotation speed and a second rotation speed.

7. The method of claim 6, and wherein a second communication channel corresponds to a third rotation speed between the first rotation speed and the second rotation speed.

8. The method of claim 1, comprising the rotary laser level actuating the first laser beam between being on and off in a first repeating pattern that corresponds to the first communication channel.

9. The method of claim 8, comprising:
determining, at the detector, a second repeating pattern of the second laser beam; and
analyzing, at the detector, whether the second laser beam is the first laser beam emitted by the rotary laser level based on whether the second repeating pattern matches the first repeating pattern.

10. The method of claim 9, comprising:
determining, at the detector, a detected rotational direction of the second laser beam; and
analyzing the detected rotational direction to determine whether the second laser beam is the first laser beam emitted by the rotary laser level.

11. The method of claim 1, wherein the second signal received at the detector is generated as a result of a user-interface element on the detector being actuated.

12. A rotary laser level comprising:
a laser emitter configured to emit a rotating laser beam from the rotary laser level; and
a receiver configured to receive a signal that indicates a selection of a first communication channel from among a plurality of communication channels;
wherein the laser emitter is configured to actuate the rotating laser beam between being on and off in a repeating pattern that corresponds to the first communication channel.

13. The rotary laser level of claim 12, the laser emitter is configured to:
confirm the rotating laser beam is rotating in a first rotational direction that corresponds to the first communication channel.

14. The rotary laser level of claim 12, wherein each communication channel of the plurality of communications channels corresponds to a repeating pattern that does not correspond to any of the other communications channels.

15. The rotary laser level of claim 12, wherein each communication channel of the plurality of communications channels corresponds to a rotation speed that does not correspond to any of the other communications channels.

16. The rotary laser level of claim 15, wherein the first communication channel corresponds to a first rotation speed and a second rotation speed.

17. A laser level detector comprising:
a detector panel configured to receive:
a first laser beam, wherein the first laser beam was emitted by a first emitter and is received at a first portion of the detector panel; and
receive a second laser beam at the detector panel;
a processing unit configured to:
analyze whether the second laser beam was received at the first portion of the detector panel; and
determine whether the second laser beam was emitted by the first emitter based on the analyzing whether the second laser beam was received at the first portion of the detector panel.

18. The laser level detector of claim 17, the processing unit configured to:
analyze an intensity of the second laser beam; and
determine whether the second laser beam was emitted by the first emitter based on analyzing the intensity.

19. The laser level detector of claim 17, the processing unit configured to:
determine a rotational speed of the second laser beam; and
determine whether the second laser beam was emitted by the first emitter based on determining the rotational speed of the second laser beam.

20. The laser level detector of claim 17, the processing unit configured to:
determine a rotational direction of the second laser beam; and
determine whether the second laser beam was emitted by the first emitter based on determining the rotational direction of the second laser beam.
